(19) United States
(12) Patent Application Publication
(10) Pub. No.: US 2009/0292685 A1
(43) Pub. Date: Nov. 26, 2009

(54) VIDEO SEARCH RE-RANKING VIA MULTI-GRAPH PROPAGATION

(75) Inventors: Jingjing Liu, Cambridge, MA (US); Xian-Sheng Hua, Beijing (CN); Wei Lai, Beijing (CN); Shipeng Li, Palo Alto, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/125,059

(22) Filed: May 22, 2008

(51) Int. Cl. G06F 7/06; G06F 17/30

(52) U.S. Cl. 707/5; 707/E17.017

(57) ABSTRACT

A video search re-ranking via multi-graph propagation technique employing multimodal fusion in video search is presented. It employs not only textual and visual features, but also semantic and conceptual similarity between video shots to rank or re-rank the search results received in response to a text-based search query. In one embodiment, the technique employs an object-sensitive approach to query analysis to improve the baseline result of text-based video search. The technique then employs a graph-based approach to text-based search result ranking or re-ranking. To better exploit the underlying relationship between video shots, the re-ranking scheme simultaneously leverages textual relevancy, semantic concept relevancy, and low-level-feature-based visual similarity. The technique constructs a set of graphs with the video shots as vertices, and the conceptual and visual similarity between video shots as hyperlinks. A modified topic-sensitive PageRank algorithm is then applied to these graphs to determine the overall relevancy ranking.

### BACKGROUND

There is a rapid growth of online video data as well as personal video recordings. In order to successfully manage and use such enormous multimedia resources, users need to be able to conduct semantic searches efficiently and effectively. Video search is an active and challenging task. It is defined as searching for relevant video segments/clips or video shots with issued textual queries (keywords, phrases, or sentences) and/or provided video clips or image examples (or some combination of the two). Many search approaches have been tested in recent years, ranging from plainly associating video shots with text search scores to sophisticated fusions of multiple modalities. It has been proven that the additional use of other available modalities besides text, such as image content, audio, face detection, and high-level semantic concept detection can effectively improve pure text-based video search.

A typical video search system consists of several main components such as, for example, query analysis, uni-modal search models, and search result re-ranking through multimodal fusion. By analyzing a given query with multiple types of information, different forms of the query (text, image, video, and so on) are input to individual search models, such as a text-based search model, a query by example (QBE) model or a concept detection model. Then a fusion model is applied to aggregate the search results of the multimodalities.

Some video retrieval systems tend to get the most improvement in a multimodal fusion fashion by leveraging text search engines, multiple query example images, and specific semantic concept detectors. However, applying a universal fusion model independent of queries leads to much noise and inaccuracy. Leveraging multimodalities across various textual and visual information sources, though promising, strongly depends on the characteristics of the specified queries. Therefore, in most multimodal fusion systems for video search, different fusion models are constructed for different query classes.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The video search re-ranking via multi-graph propagation technique described herein employs multimodal fusion in video search. It employs not only textual and visual features, but also semantic and conceptual similarity between video shots to rank or re-rank the search results received in response to a text-based search query.

More specifically, in one embodiment, the technique employs an object-sensitive approach to query analysis to improve the baseline result of text-based video search. (It should be noted that this object-sensitive approach to query analysis can be used in other methods of video search besides the video search re-ranking via multi-graph propagation technique described herein. Likewise, the video search re-ranking via multi-graph propagation technique can be used without the object-sensitive approach to query analysis.) The technique then employs a graph-based approach to text-based search result ranking or re-ranking. To better exploit the underlying relationship between video shots, the re-ranking scheme simultaneously leverages textual relevancy, semantic concept relevancy, and low-level-feature-based visual similarity. The technique constructs a set of graphs with the video shots as vertices, and conceptual and visual similarity between video shots as “hyperlinks.” A modified topic-sensitive PageRank algorithm is then applied to these graphs to propagate the relevance scores through all related video shots to determine the overall relevancy ranking of the video shots.

In the following description of embodiments of the disclosure, reference is made to the accompanying drawings which form a part hereof, and in which are shown, by way of illustration, specific embodiments in which the technique may be practiced. It is understood that other embodiments may be utilized and structural changes may be made without departing from the scope of the disclosure.

### DESCRIPTION OF THE DRAWINGS

The specific features, aspects, and advantages of the disclosure will become better understood with regard to the following description, appended claims, and accompanying drawings where:

FIG. 1 provides an overview of one possible environment in which video searches are typically carried out.

FIG. 2 is a diagram depicting one exemplary architecture in which one embodiment of the video search re-ranking via multi-graph propagation technique can be employed.

FIG. 3 is a flow diagram depicting an exemplary embodiment of a process employing one embodiment of the video search re-ranking via multi-graph propagation technique.

FIG. 4 is an exemplary flow diagram depicting an object-sensitive query analysis which can be employed to improve video shot search results received in response to a search query.

FIG. 5 is an exemplary graph of a set of video shots created by one embodiment of the video search re-ranking via multi-graph propagation technique. The video shots are shown as vertices.

FIG. 6 is an exemplary graph based on the specific concept “car”.

FIG. 7 is an exemplary graph pruned based on visual similarity of pairs of video shots.

FIG. 8 is an exemplary graph re-constructed with directed hyperlinks.

FIG. 9 is a schematic of an exemplary computing device in which the video search re-ranking via multi-graph propagation technique can be practiced.

### DETAILED DESCRIPTION

In the following description of the video search re-ranking via multi-graph propagation technique, reference is made to the accompanying drawings, which form a part thereof, and which is shown by way of illustration examples by which the video search re-ranking via multi-graph propagation technique described herein may be practiced. It is to be understood that other embodiments may be utilized and structural changes may be made without departing from the scope of the claimed subject matter.

1.0 Video Search Re-Ranking Via Multi-Graph Propagation Technique.

The following section provides an overview of the video search re-ranking via a multi-graph propagation technique, an exemplary architecture wherein the technique can be practiced, exemplary processes employing the technique and details of various implementations of the technique.

1.1 Overview of the Video Search Re-Ranking Via Multi-Graph Propagation Technique

As the baseline of multimodal fusion in computer or network searches, text-based video search dominates. Existing information retrieval (IR) methods based on plain text have been studied for many years. However, when applied to video search, these approaches are far from acceptable, although they are mature and effective on text search tasks. The poor performance of text-based retrieval methods applied directly to video search is due to the difference between typical queries employed in video search and those in text search. For text search tasks, the queries are mostly semantic concepts (such as “web ontology” and “xml protocol”), the searching of which rely upon the search strings' relevance to the context of documents. Video search, however, is a task more content and visually based, yet relatively less text-relevant.

Relative relevance dependent on a given topic exists in video search tasks. In a video corpus, each video clip is annotated with a set of semantic concepts, which represent the semantic content of the video clip. Therefore, given a query topic in text, the video clip whose concept labels are similar to the given topic is more likely to be relevant to the query. This is similar to the relevance of web pages to a given topic in web search tasks. Moreover, video shots are not independent of each other, but have mutual relations such as conceptual and visual similarity. This can be taken as the underlying “hyperlink” between video shots, similar to that between web pages. Therefore, by adopting a topic-sensitive web page ranking procedure into video search, the technique described herein determines the relevance of video shots to a given query from these hyperlinks using conceptual and visual similarity of pairs of video shots, which improves the ranking results of a pure text-based search model.

In the current video search re-ranking via multi-graph propagation technique, the technique takes the relevance of text-based search results as the baseline for re-ranking the relevance of the video shots. In video search tasks, queries are often “object-centric,” searching for some visual objects, such as a person, an event and a scene. Such objects are named “targeted objects” in a query. The query terms representing the targeted objects are considered differently from those describing the background of the targeted objects. In one embodiment, the technique employs an approach to query analysis for improving the text-based search baseline. In this approach, the technique identifies the targeted objects in a video search query and specially processes the query terms that represent the targeted objects. Specifically, the technique converts a text string query into an object query. This approach is called “object-sensitive query analysis” for video search. In one embodiment of the video search re-ranking via multi-graph propagation technique, this systematic query analysis process is placed before the text search stage to improve the search results.

The video search re-ranking via multi-graph propagation technique also employs a modified PageRank-like approach to video search re-ranking. More specifically, in one embodiment, the text search results (improved or not) are taken as the baseline to create graphs based on multimodal fusion. The technique exploits the conceptual as well as visual similarity to build virtual hyperlinks between video shots. By taking the video shots as the vertices and the hyperlinks as the edges, the technique can construct a set of hierarchical graphs for different semantic concepts. The technique applies a modified topic-sensitive PageRank procedure to these graphs to propagate the text-based relevance scores of video shots through the hyperlinks in each graph. The aggregated results of the propagated scores from the multiple graphs are taken as the final ranking results of the search task.

The video search re-ranking via multi-graph propagation technique can be adapted to generic types of queries as the technique is independent of query classes and requires no training data for query categorization. Also, it requires no involvement of human effort as the relevance of video shots to a given topic is propagated through the multiple graphs automatically. Furthermore, the fusion across textual, visual and semantic conceptual information can be implemented in a graph-based iterative style, which combines the information from multimodalities in a natural and sound way. The graph-based propagation method of video search re-ranking significantly improves the performance of text-based search baseline.

1.2 Search Environment

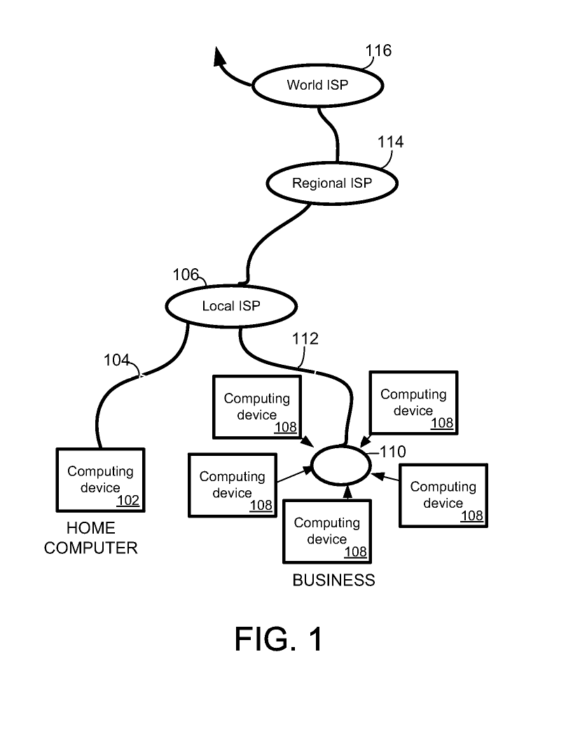

FIG. 1 provides an overview of an exemplary environment in which searches on the Web or other network, may be carried out. Typically, a user searches for information on a topic, images or video clips on the Internet or on a Local Area Network (LAN) (e.g., inside a business).

The Internet is a collection of millions of computers linked together and in communication on a computer network. A home computer 102 may be linked to the Internet or Web using a telephone line, a digital subscriber line (DSL), a wireless connection, or a cable modem 104 that talks to an Internet Service Provider (ISP) 106. A computer in a larger entity such as a business will usually connect to a local area network (LAN) 110 inside the business. The business can then connect its LAN 110 to an ISP 106 using a high-speed line like a T1 line 112. ISPs then connect to larger ISPs 114, and the largest ISPs 116 typically maintain networks for an entire nation or region. In this way, every computer on the Internet can be connected to every other computer on the Internet.

The World Wide Web (referred sometimes as the Web herein) is a system of interlinked hypertext documents accessed via the Internet. There are billions of pages of information, images and video available on the World Wide Web. When a person conducting a search seeks to find information on a particular subject or an image of a certain type they typically visit an Internet search engine to find this information on other Web sites via a browser. Although there are differences in the ways different search engines work, they typically crawl the Web (or other networks or databases), inspect the content they find, keep an index of the words they find and where they find them, and allow users to query or search for words or combinations of words in that index. Searching through the index to find information typically involves a user building a search query and submitting it through the search engine via a browser or client-side application. Text, images and video on a Web page returned in response to a query can contain hyperlinks to other Web pages at the same or different Web site. It should be noted that computer-based searches work in a similar manner to network searches, but a database tagged with metadata on a user's computing device is searched with the search query.

1.3 Exemplary Architecture Employing an Embodiment of the Video Search Re-Ranking Via Multi-Graph Propagation Technique.

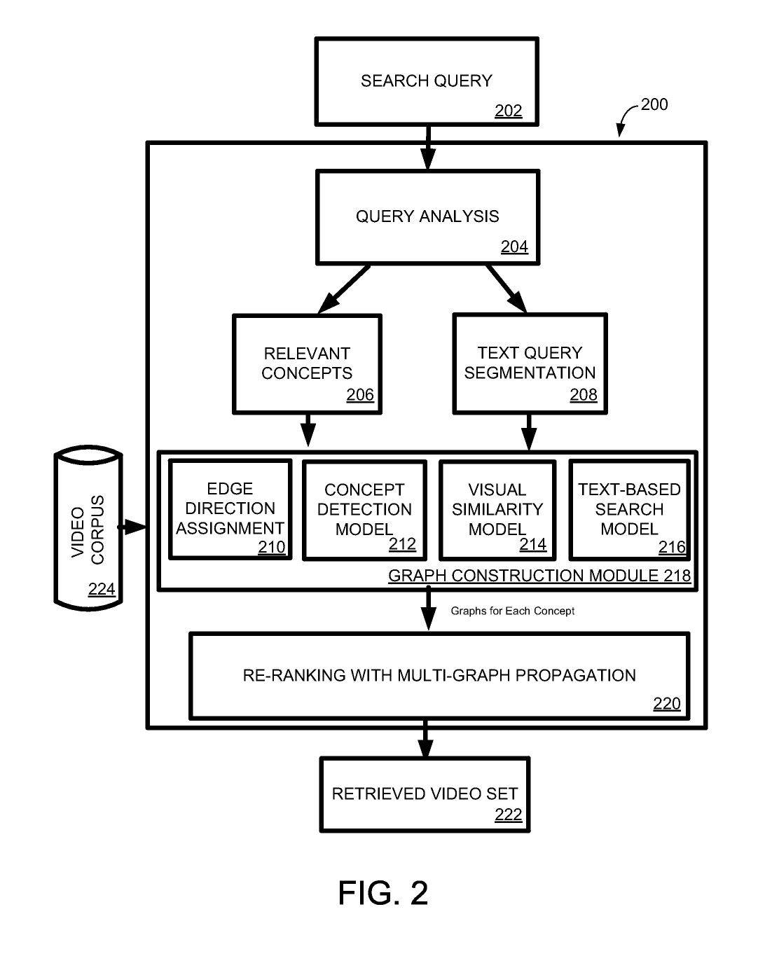

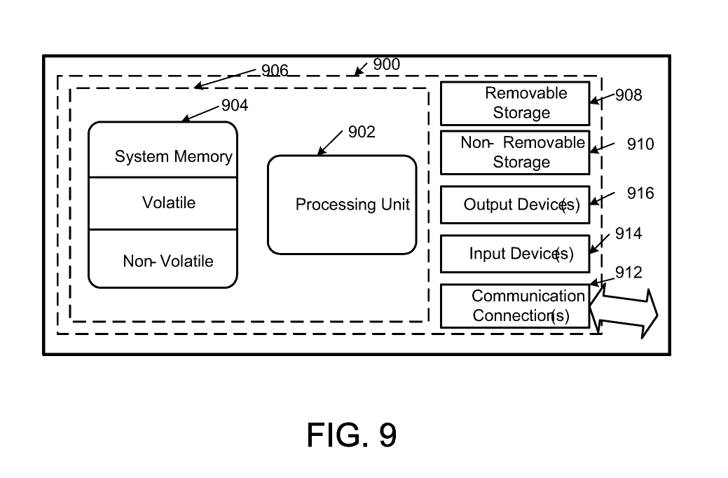

One exemplary architecture that includes a video search re-ranking module 200 (typically residing on a computing device 900 such as discussed later with respect to FIG. 9) in which the video search re-ranking via multi-graph propagation technique can be practiced is shown in FIG. 2. A search query 202 which typically includes a text string is input into the video search re-ranking module 200. Query analysis can take place in a query analysis module 204. For example, query analysis can take place by analyzing the query as it pertains to relevant concepts (module 206) and by breaking down the query into combinations of text terms (module 208). The relevant concepts (206) and combinations of terms (208) can then be input into a graph construction module (218) can contain various models 210, 212, 214, 216, and that creates graphs that represent search results of the video corpus 224. The various models include a concept detection module 212, a visual similarity model 214 and a text-based search model 216. These graphs are based on different semantic concepts with video shots as vertices and hyperlinks between video shots as edges. The hyperlinks exploit conceptual as well as visual similarity between the video shots. The graph construction module 218 also contains an edge direction assignment module 210 which assigns directions to the hyperlinks of the graphs. A more detailed description of how these graphs are constructed will be provided later. These created graphs constructed in the graph construction module 218 are then into a multi-graph propagation module 220. This multi-graph propagation module 220 uses the graphs constructed in the graph construction module 218 to rank the relevance of search results of the video corpus 224 received in response to the query 202.

1.4 Exemplary Processes Employing the Video Search Re-Ranking Via Multi-Graph Propagation Technique and Object Sensitive Query Analysis.

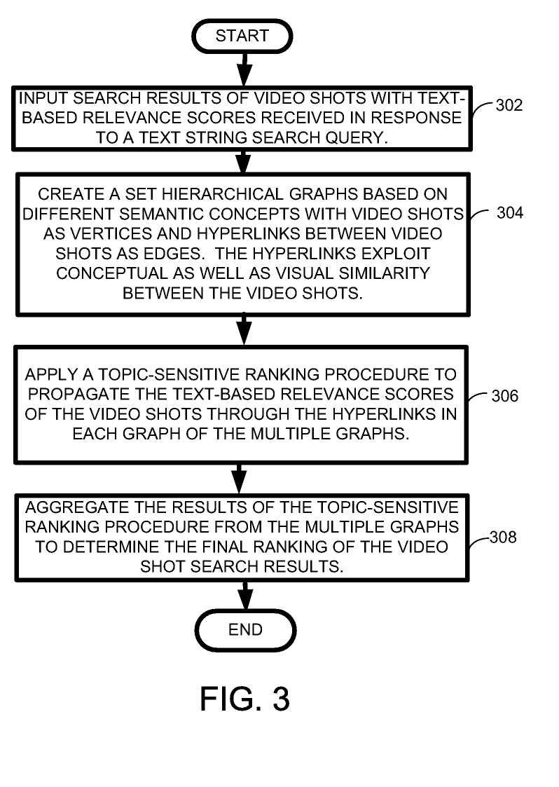

An exemplary process employing the video search re-ranking via multi-graph propagation technique is shown in FIG. 3. As shown in FIG. 3, (box 302), search results of video shots with text-based relevance scores received in response to a text string search query are input. A set of hierarchical graphs are then created (box 304). These graphs are based on different semantic concepts with video shots as vertices and hyperlinks between video shots as edges. The hyperlinks exploit conceptual as well as visual similarity between the video shots. A topic-sensitive ranking procedure is then applied to propagate the text-based relevance scores of the video shots through the hyperlinks in each graph of the multiple graphs (box 306). Then, as shown in box 308, the results of the topic-sensitive ranking procedure from the multiple graphs are aggregated to determine the final ranking of the video shot search results.

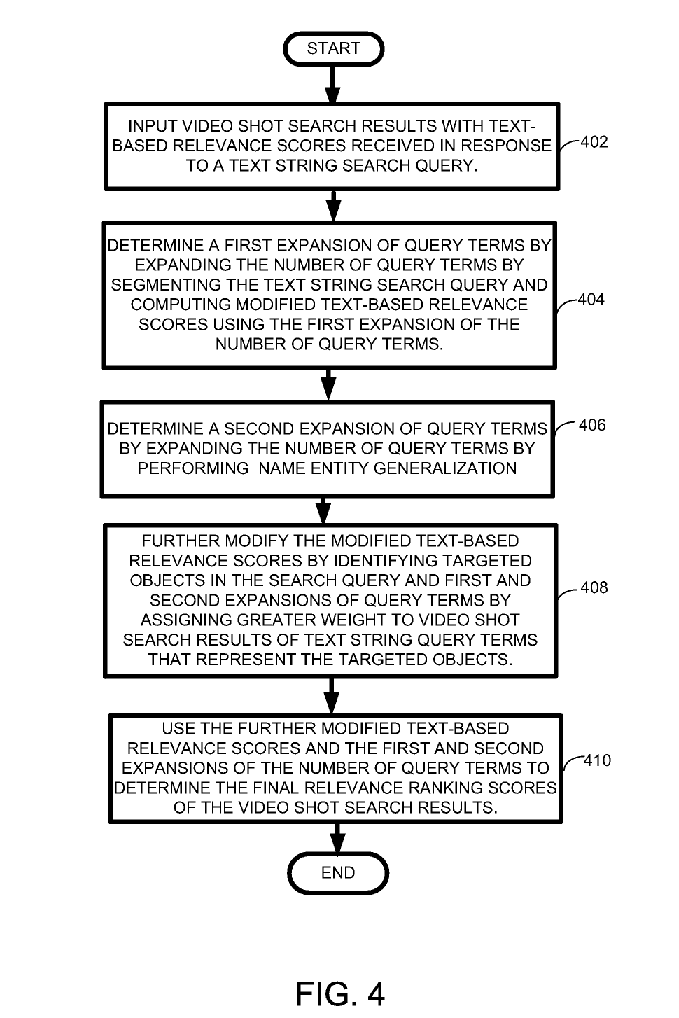

In one embodiment of the video search re-ranking via multi-graph propagation technique an object-sensitive query analysis is performed to modify the text-based relevance scores of the video shots before the graphs are created. The modified text-based relevance scores are then used in graph creation. The object-sensitive query analysis can be used to assign greater weight to targeted objects of a search. It should be noted that this object-sensitive approach to query analysis can be used in other methods of video search besides the video search re-ranking via multi-graph propagation technique. Likewise, the video search re-ranking via multi-graph propagation technique can be used without the object-sensitive approach to query analysis. One exemplary process of performing this object-sensitive query analysis is shown in FIG. 4. As shown in box 402, video shot search results with text-based relevance scores received in response to a text string search query are input. A first expansion of query terms is determined by expanding the number of query terms by segmenting the text string search query (box 404). This first expansion of query terms is used to compute modified text-based relevance scores using the first expansion of the number of query terms (box 404). A second expansion of the number of query terms is then determined by performing name entity generalization (box 406). Name entity generalization will be discussed in more detail later. As shown in box 408, the modified text-based relevance scores are further modified by identifying targeted objects in the text string search query and the first and second expansions of query terms. Greater weight is assigned to video shot search results of query terms that represent the targeted objects (box 408). The further modified text-based relevance scores and the first and second expansion of query terms are then used to determine the final relevance scores of the video shot search results (box 410).

It should be noted that many alternative embodiments to the discussed embodiments are possible, and that steps and elements discussed herein may be changed, added, or eliminated, depending on the particular embodiment. These alternative embodiments include alternative steps and alternative elements that may be used, and structural changes that may be made, without departing from the scope of the disclosure.

1.5 Exemplary Embodiments and Details.

The following paragraphs provide details and alternate embodiments of the exemplary architecture and processes presented above. In this section, the details of possible embodiments of the video search re-ranking via multi-graph propagation technique and object-sensitive query analysis will be discussed.

1.5.1 Object-Sensitive Query Analysis

1.5.1.1 Text-Based Search Baseline

As previously mentioned, text-based search is an important baseline for video search. In one embodiment, the video search re-ranking via multi-graph propagation technique described herein updates the states of the graphs in an iterative style, thus the performance of the propagation process relies much upon the initialization of the created graphs, i.e. the search results from text-based search model.

In one embodiment of the video search re-ranking via multi-graph propagation technique, to raise the bar of the text-based search baseline, the technique employs an approach, namely “object-sensitive query analysis,” which significantly improves the text-based search results used to create the graphs, as previously shown in FIG. 4. In one embodiment of the object-sensitive query analysis, N-gram query segmentation (box 404), name entity generalization (box 406), and object-sensitive query term re-weighting (box 408), are applied to a query. Specifically, in one embodiment, in object-sensitive query term re-weighting, any combination of four methods are employed to identify the targeted objects. These four methods can include visual content-based semantic concept detection, part-of-speech (POS) identification, adverb refinement, and name entity reference highlight. For the completeness of this description of the video search re-ranking via multi-graph propagation technique, the details of the query analysis approach, as described with respect to FIG. 4, will be briefly reviewed in this section.

1.5.1.2 N-Gram Query Segmentation

As shown in FIG. 4, box 404, before inputting the query topic string into the search engine, the technique first segments the query into term sequences based on the known N-gram method. Given a query like “find shots of one or more people reading a newspapers”, the key terms (“people,” “read,” and “newspaper” in this example) are retained after stemming (such as converting “reading” to “read”) and stopwords (such as “a” and “of”) removing. The technique applies the N-gram segmentation to the remained keywords. This particular example has three levels of N-gram (i.e., N is from 1 to 3). Therefore, seven query segments can be generalized as:

Unigram: people⁽¹⁾, read⁽²⁾, newspaper⁽³⁾;

Bigram: people read⁽⁴⁾, read newspaper⁽⁵⁾, people newspaper⁽⁶⁾;

Trigram: people read newspaper⁽⁷⁾.

These segments can be input in to a search engine as different forms of the query, and the relevance scores of video shots retrieved by different query segments can be aggregated with different weights which can be set empirically. The higher gram a query segment has, the more relevant to the given query the corresponding video shots retrieved by this segment should be, and therefore a higher weight is assigned. In the above example, the video shots retrieved by “people read newspaper” n-gram are given a higher aggregation weight than those retrieved by “people read.”

1.5.1.3 Name Entity Generalization

Most queries for video search tasks contain the terms representing a name entity, such as a person, a place and a vehicle. In one embodiment of this technique, a query expansion method for the refinement of queries with name entities is employed. The method is herein named “name entity generalization.” In one embodiment, as shown in box 406 of FIG. 4, object sensitive query analysis classifies name entities into several predefined categories, and gives each name entity a label of its corresponding category. The extraction of name entities and the application of the generalization method to query expansion are detailed as follows.

First, using an automatic name entity recognition tool known to those with ordinary skill in the art, the technique identifies name entities occurring in both queries and a text corpus associated with the video data. Then, a label of “name entity category” (such as “<person name>”) is given to each identified name entity. For example, given a query “find shots with one or more people leaving or entering a vehicle,” it will be tagged as: “find shots with one or more people<person name> leaving or entering a vehicle<vehicle name>.” Similarly, the technique tags the name entities appearing in the text corpus of video data as well, e.g. “Peter<person name> walks out of the car<vehicle name>.”

With this generalization method, name entities in both query and the text corpus are tagged with the same set of category labels. Therefore, the relevant text segments which have no “direct” match to the original query can now be retrieved with these shared labels. As shown in the example above, the sentence which contains no query term before name entity generalization now can be retrieved by the labels which also occur in the expanded query.

1.5.1.4 Object-Sensitive Query Term Re-Weighting

1.5.1.4.1 Query Term Frequency

In general, in text search methods, all the query terms are treated equally, except that the term frequency in query (qtf) is taken into consideration, e.g. in the well known BM25 algorithm which is used for text relevance calculation:

$$revelance = {\sum }_{T ∈ Q} ω \frac{( {k}_{1} + 1 ) tf ( {k}_{2} + 1 ) qtf}{( K + tf ) ( {k}_{2} + qtf )} \qquad ( 1 )$$

where Q is a query consisting of term T; tf is the occurrence frequency of the term T within the text segment, qtf is the frequency of the term T within the topic from which Q was derived, and ω is the Robertson/Sparck Jones weight of T in Q. K is calculated by:

$$K = {k}_{1} ( ( 1 - b ) + b * \frac{dl}{avdl} ) \qquad ( 2 )$$

where dl and avdl denote the document length and the average document length, respectively. k₁, k₂ and b are empirically set parameters. However, in the query of a video search task, qtf of all the terms is usually equal to “1,” since there are rare terms occurring more than once in the query topic. Furthermore, merely using the query term frequency fails to consider the evidence of the semantic importance of different query terms. Therefore, as shown in FIG. 4, box 408, to exploit the specific semantic characteristics of video queries and to better assess the importance of different query terms, object sensitive query analysis employs an object-sensitive query term re-weighting approach, which aims to distinguish the query terms representing the targeted objects from others representing the background of the targeted objects.

1.5.1.4.2 Identification of a Targeted Object

To detect the targeted objects in a video search query, in one embodiment object sensitive query analysis employs four identification methods which are: visual content-based semantic concept detection, POS (part-of-speech) identification, adverb refinement and name entity reference highlight, respectively.

A. Visual Content-Based Semantic Concept Detection

Content-based semantic concept detection is a widely used method for video annotation and retrieval. A semantic concept is an abstract description of the content of a video shot, for example, “person,” “sports,” and so on. There are many public concept dictionaries, such as the Lexicon Definitions and Annotations concept list (LSCOM) which has become a general standard of concept detection and evaluation. It consists of more than 800 generic concepts, which represent the most important semantic concepts of video content. In one embodiment of object sensitive query analysis, LSCOM is taken as the concept dictionary and each query term is compared with the concept list in LSCOM. When there is a direct match between a query term and a concept of the list, the corresponding term is identified as a concept tag of the targeted video shots. Thus, this query term is taken as the targeted object in the query.

B. Part-of-Speech Identification

In order to assess the syntactic characteristics of query terms, the technique constructs POS (part-of-speech) tagging on the query with an automatic POS tagging tool. Part-of-speech represents the syntactic property of a term, e.g. noun, verb, adjective, etc. By labeling the query topic with POS tags, the terms with noun or noun phrase tags can be extracted as the targeted objects, as the noun and noun phrases often describe the centric objects that the query is inquiring for. For example, given a query “find shots of one or more people reading a newspaper,” “people” and “newspaper” will be tagged as noun and extracted as the targeted objects in the query.

C. Adverb Refinement

Although extracted as targeted objects, the noun and noun phrases at different positions of a sentence should be treated unequally due to their different importance. For example, noun or noun phrases following an adverb with refinement meanings (such as “with” and “at least”) represent the objects that must appear in the targeted video shots. The object sensitive analysis identifies the adverbs with refinement meanings and takes the noun or noun phrases following these adverbs as targeted objects, e.g. the “boats” or “ships” in the query “find shots of water with one or more boats or ships.”

D. Name Entity Reference Highlight

As mentioned previously, name entities in the query can be identified with an automatic entity recognition tool. However, the different terms of a name entity do not always share the same occurrence rate. For example, in the reference of a publication, the author is more often referred by last name rather than by first name. Based on such observation, object sensitive query analysis extracts the underlying targeted object in name entities by identifying the part which is more often used as the reference of the name entity. Take “George Bush” as an example. “Bush” occurs more often than “George” in the speech transcripts of broadcasted news when referring to “George Bush.” And at most time, “Bush” refers to “George Bush” while “George” often refers to someone else. The object sensitive query analysis calculates the frequency of different parts of a name entity from external data corpus, such as web search results, and selects the most frequent part as the targeted object in the query.

1.5.1.4.3 Modified BM25 Algorithm

As shown in FIG. 4, box 410, to emphasize the contribution of the terms representing targeted objects in the query, one can define a modified qtf_{new} for the BM25 equation (1):

$$\begin{matrix}{qtf}_{new} = {\sum }_{i} {w}_{i} * {O}_{i} ( t ) + {qtf}_{old} & ( 3 ) \\ {O}_{i} ( t ) = \{ \begin{matrix}1 & if t is an targeted object ; \\ 0 & otherwise .\end{matrix} & ( 4 )\end{matrix}$$

where qtf_{old} represents the original query term frequency within the query topic as defined in (1). Oᵢ(t) represents an indicator function which predicts whether a term t represents a targeted object or not; wᵢ represents the weight assigned to the targeted object term detected by one of the four specific target object identification methods previously discussed (i=1, 2, 3, 4). In special cases where a term is detected as the targeted object by more than one method, the scores from multiple methods are aggregated and assigned to the term as a combined score. Specifically, in the case where the term is not detected as a targeted object by any method, the qtf_{new} will remain the same as the original query term frequency (qtf_{old}). To combine the object-sensitive approach to query analysis with the text retrieval baseline in video search, object sensitive query analysis modifies the original BM25 algorithm to an object-centric BM25 algorithm with the modification of qtf in equation (3) and (4):

$$relevance = {\sum }_{T ∈ Q} ω \frac{( {k}_{1} + 1 ) tf ( {k}_{2} + 1 ) ( \sum w * O ( j ) + {qtf}_{old} )}{( K + tf ) ( {k}_{2} + \sum w * O ( j ) + {qtf}_{old} )} \qquad ( 5 )$$

In the modified object-centric BM25 algorithm, not only the query term frequency is considered, but also the object-based semantic importance of the query terms is taken into consideration. The object-sensitive query analysis approach enhances the performance of pure text-based methods employed in video search.

1.5.2 Video Search Re-Ranking

The traditional multimodal fusion method in video search is typically a simple linear aggregation of search results from multimodalities, which does not exploit the underlying relationship between multimodalities. Furthermore, although the linear fusion method is easy to implement, much training data and human input are required.

As previously mentioned, there is an analogy between video shots and web pages: with the virtual “hyperlinks” indicating semantic relationships, video shots can construct a hierarchical structure similar to the hyperlinked web page structure. By adopting a similar method to web page ranking utilizing hyperlinks, the video search problem can be addressed in a graph-based ranking fashion utilizing the hyperlinks of video shots as well. Recently, the most widely used web page ranking algorithm is PageRank developed in 1998. The video search re-ranking via multi-graph propagation technique employs a modified PageRank procedure for video search re-ranking. To give a better explanation of the proposed algorithm, a brief introduction of the PageRank algorithm and its modifications will first be presented.

1.5.2.1 PageRank Algorithm

A typical random walk method for web page processing through hyperlinks is the PageRank algorithm, which is widely used in web page retrieval tasks. An assumption in the PageRank algorithm is that the hyperlinks between web pages indicate the relative importance of web pages—the more hyperlinks point to a web page, the more important this web page is. In the original PageRank algorithm, a single PageRank vector is computed to capture the relative importance of web pages, using the link structure of the web independent of any particular search query.

The PageRank algorithm is a well known algorithm which includes some variations such as the static PageRank algorithm, such as the dynamic PageRank algorithm, and the relevance-based intelligent surfer PageRank algorithm.

1.5.2.1.1 Static PageRank Algorithm

In the static Page Rank algorithm an alternative model of page importance was introduced, called the random surfer model. In that model, a surfer on a given page i, with probability (1−d) chooses to select uniformly one of its out-links O(i), and with probability d jumps to a random page from the entire web W. The PageRank score for vertex (page) i is defined as the stationary probability of ending the random surfer at vertex i. One formulation of PageRank is given by:

$$PR ( i ) = ( 1 - d ) {\sum }_{j \text{:} j \to i} \frac{Pr ( j )}{O ( j )} + d \frac{1}{N} \qquad ( 6 )$$

The static PageRank algorithm is a query-independent measure of the importance of web pages. It is only related to the hyperlink structure of the entire web and has no bias to specific topics.

1.5.2.1.2 Dynamic PageRank Algorithm

In the Topic-Sensitive PageRank (TSPR), a set of topics consisting of the top level categories of the Open Directory Project (ODP), are selected, with τᵢ as the set of URLs within topic cⱼ. (ODP, also known as dmoz (from directory.mozilla.org, its original domain name), is a multilingual open content directory of World Wide Web links that is constructed and maintained by a community of volunteer editors. ODP uses a hierarchical ontology scheme for organizing site listings. Listings on a similar topic are grouped into categories, which can then include smaller categories.) Multiple PageRank calculations are performed on each topic, respectively. When computing the PageRank vector for topic cⱼ, the random surfer will jump to a page in τᵢ at random rather than just to any page in the whole web. This has the effect of biasing the PageRank to that topic. Thus, page k's score on topic cⱼ can be defined as:

$${TSPR}_{j} ( k ) = ( 1 - d ) {\sum }_{i \text{:} i \to k} \frac{{TSPR}_{j} ( i )}{O ( i )} + d \frac{1}{N} \qquad ( 7 )$$

To rank results for a particular query q, let r(q, cⱼ) be q's relevance to topic cⱼ. For web page k, the query sensitive importance score is given by:

$${S}_{q} ( k ) = {\sum }_{j} {TSPR}_{j} ( k ) * r ( q , {c}_{j} ) \qquad ( 8 )$$

The relevance results of web pages to a given query are ranked according to this composite score.

1.5.2.1.3 The Intelligent Surfer

Another PageRank algorithm called the intelligent surfer PageRank algorithm (ISPR) also exists. In this algorithm the surfer is prescient, selecting links (or jumps) based on the relevance of the target to the query of interest. In such a query-specific version of PageRank, the surfer still has two choices: follow a link, with probability (1−d), or jump with probability d. However, instead of selecting among the possible destinations equally, the surfer chooses the target using a probability distribution generated from the relevance of the target to the surfer's query. Thus, for a specific query q, page j's query-dependent score can be calculated by:

$${IS}_{q} ( j ) = d \frac{r ( q , j )}{{\sum }_{k ∈ w} r ( q , k )} + ( 1 - d ) {\sum }_{i \text{:} i \to j} \frac{{IS}_{q} ( i ) ( r ( q , j ) )}{{\sum }_{i \text{:} i \to i} r ( q , l )} \qquad ( 9 )$$

1.5.3 Multi-Graph Construction

The video search re-ranking via multi-graph propagation technique formulates the video search problem in a graph-based fashion, by exploiting the analogy between video shots and web pages. The technique constructs hyperlinked graphs of video shots similar to those of web pages. Then the technique applies a modified topic-sensitive PageRank procedure to propagate the relevance scores of video shots through these graphs. The video shots are then re-ranked according to the aggregation scores of the multi-graph based propagation. In the following paragraphs, details of the exemplary architecture and process of employing video search by constructing the hyperlinked graphs of video shots will be discussed.

1.5.3.1 Text-Based Search Model

The text-based search model is the baseline of most multimodal fusion methods. The video search re-ranking via multi-graph propagation technique takes text-based search results as the baseline of the multi-graph re-ranking model. The text-based search model, as shown in FIG. 2, block 216, will be described in more detail in the paragraphs below.

A more formal definition of text retrieval in video search problem is: given a query in text, estimate the relevance R(x) of each video shot x in the search set X (x^{ε}X) to the query, and order them by their relevance scores. The relevance of a shot is given by the relevance score between the associated text of the shot and the given text query.

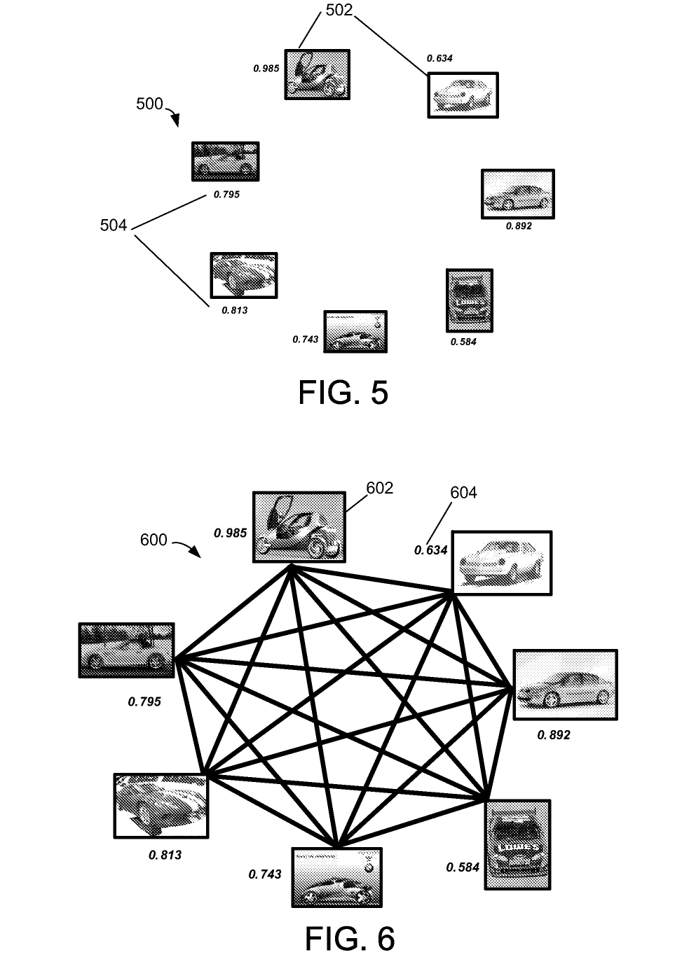

With the text-based search model presented previously, each video shot is assigned with a relevance score on the given text query. The higher relevance score, the higher likelihood that the shot is related to the given query. Given the retrieved video shots and their relevance scores, the video search re-ranking via multi-graph propagation technique treats the video shots in a similar way to the retrieved web pages in a web search task. The technique takes the video shots as vertices, and constructs a vertex-weighted graph with these video shots. The text-relevance score of each shot is considered as the weight of each vertex, similar to the relevance score of each web page to the given topic in a web search task. The video shots that are irrelevant to the query (identified by text-based search model) have a default relevance score equal to zero. An exemplary graph 500 of a set of video shots 502 is shown in FIG. 5. Each video shot 502 is associated with a text-based relevance score 504.

1.5.3.2 Concept Detection Model

Semantic concept detection is a widely studied topic in multimedia research. A concept detection model, as shown in FIG. 2, box 212, predicts the likelihood of a video shot being related to a given concept, and classifies the video shots into positive category (relevant) and negative category (irrelevant) on a given concept.

One embodiment of the technique employs a concept detection model 212 to assess the virtual semantic relations between video shots. The technique can use several models to implement concept detection, such as SVM (Support Vector Machines), manifold ranking and transductive graphs. Briefly speaking, these models detect the relevance of each video shot to a specific concept, and rank the video shots according to their “confidence scores” of being relevant to the concept.

With the concept detection model 212, the technique can compute a set of relevant video shots to each concept. The set of relevant video shots to a specific concept are not independent of each other, but share some semantic relationship. This relationship is similar to the case of web pages. A pair of web pages which have a hyperlink between each other share some semantic relationship, which is indicated by the anchor texts of the hyperlink. Similarly, the concept to which a set of video shots are related indicates the semantic meanings of the contents of these video shots. Therefore, the semantic meaning which is shared by a pair of video shots can be taken as the hyperlink between each other as well, with the corresponding concept as the anchor text associated with each shot.

Given a query, the technique can select a set of concepts that are highly relevant to the query from a concept dictionary. The relevant concepts to a given query can be retrieved through typical text processing methods, such as surface-string similarity computation, context similarity comparison, ontology and dictionary matching. For each concept mapped to the query, the technique can obtain from the concept detection model 212 a set of video shots which are relevant to the concept. Then the technique builds a virtual “hyperlink” between each pair of these video shots indicating that the two shots have a semantic concept similarity.

Thus, for the set of concepts mapped to a given query, there will be a set of graphs constructed based on individual concepts. Each graph consists of all the video shots 602 that are relevant to the corresponding concept. FIG. 6 illustrates an exemplary graph 600 constructed on a specific concept “car.” The vertices of the graph 602 are video shots that are relevant to the concept “car.” Each vertex contains a text-relevance score 604 generated from the text-based search model 216, as well as a confidence score of being relevant to the concept “car” generated from the concept detection model 212. This graph 600 indicates that there is a semantic concept similarity between each pair of the hyperlinked video shots, and the similarity refers to the concept “car.”

1.5.3.4 Visual Similarity Model

The assumption adopted in the previously described graph construction procedure is that, if two video shots are predicted as positive instances (e.g., belong to the concept) by the concept detection model 212, they probably share a semantic conceptual similarity between each other. However, due to the limited performance of concept detection methods, two shots which are both predicted as relevant to a concept may actually have no similarity. Therefore, by reinforcing the relationship between video shots by tightening the constraint of hyperlinks generated from wrong prediction, the technique can exploit other information besides semantic concept similarity into the graph construction.

A widely used similarity measure of video shots is content-based visual similarity, which can be obtained from low-level features of video shots. As shown in FIG. 2, one embodiment of the technique employs a visual similarity comparison model 214 of these low-level features to refine the hyperlinks in the graphs of the video shots.

In one embodiment of the technique, the comparison model of visual similarity 214 is implemented as follows: the technique builds a vector for each video shot with low-level visual features (in one embodiment visual features based on color moment are used) as the vector elements. Then for each pair of video shots, the technique compares the distance of the corresponding pair of vectors (Distance(Xᵢ, Xⱼ)), and takes it as the measure of visual similarity of video shots. One form of the distance equation is aggregating the divergence of feature values on each dimension:

$$Distance ( {X}_{i} , {X}_{j} ) = {\sum }_{d} \vert {x}_{id} - {x}_{jd} \vert \qquad ( 10 )$$

where x_{id} is the value of the d-th element of the feature vector of video shot i, i.e. the d-th low-level feature of shot i.

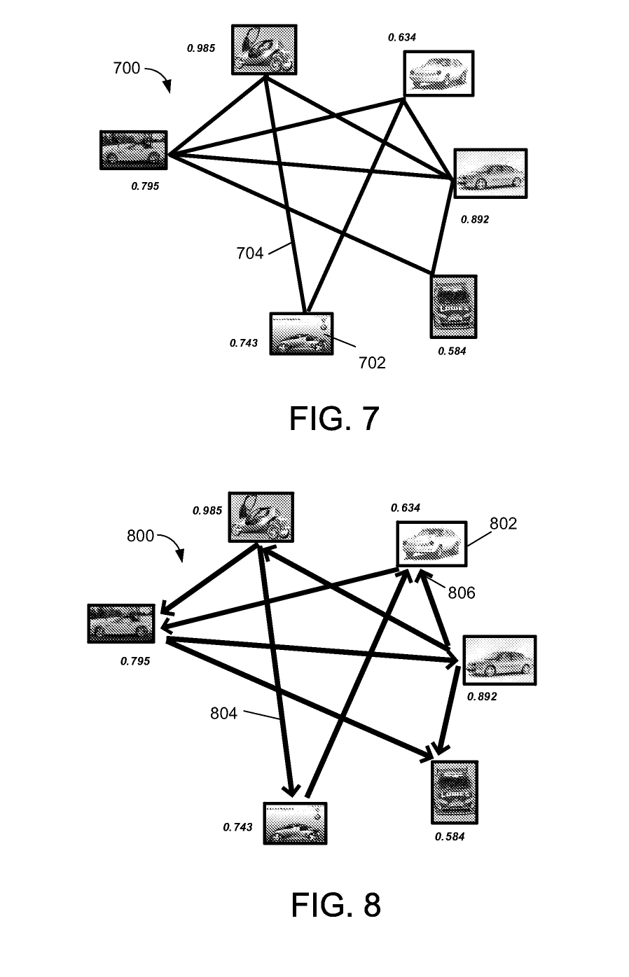

Then the technique applies a distance threshold to filter the video shot pairs which have low visual similarity. Only those pairs with a distance smaller than the threshold are taken as similar pairs. And the hyperlink between a pair of video shots which share a distance larger than the threshold are taken as pseudo-pairs and are then pruned from the graph. FIG. 7 gives an illustration of a graph 700 pruned from the aforementioned exemplary graph 600 constructed based on the concept “car” (FIG. 6). After pruning, the complete graph constructed by the concept detection model 600 is now modified to an incomplete graph 700, with only the hyperlinks 704 connecting highly relevant pairs of video shots 702 retained.

1.5.3.5 Edge Direction Assignment

In the web space, a pair of web pages which are connected by a hyperlink do not always have the same importance, especially on a specific topic. The kernel assumption in the well known PageRank algorithm is that, the web page “in-linked” by a hyperlink has a higher importance than the web page “out-linked” by the hyperlink, as a more important web page is theoretically cited more frequently than other less important ones. Similarly, although sharing a mutual relationship of conceptual and visual similarity, two video shots connected by a hyperlink in the graph do not always have the same importance in the video shot space as well.

As previously discussed, “Random walk” is another assumption in the PageRank algorithm. It is assumed that Internet surfers will “random walk” to a web page following the hyperlinks within the current web page, or randomly “jump” to a web page out of the linked set. Although the walking or jumping behavior is random, the web pages which are in-linked by more hyperlinks will have a larger probability to be visited than others which have less in-links.

This “random walk” idea can be ported into video search as well. It can be assumed the video shots retrieved by search models are a set of web pages in a web space. Therefore, when a user “surfs” among the video shots for a given query, he will “random walk” to another video shot which is in-linked by this video shot, or jump to a video shot which has no hyperlinks with the current shot. However, the probability of “walking” to an in-linked video shot is much larger, as a video shot that is more relevant to the query (in-linked by the current video shot) has a larger chance to be visited rather than other unlinked video shots. The reason is that the user has a query in mind, and is searching for relevant video shots. Thus, when he finds a relevant video shot to the query, he will prefer to follow the out-link of this video shot to a more relevant shot, in order to reach the targeted video shots.

As a concept related to the given query is a bridge between the video shots and the query, the video shot which contains a higher confidence score of concept detection on this specific concept is more relevant to the query than a shot that has a lower confidence score. Therefore, in one embodiment, as shown in FIG. 2, box 210, the video search re-ranking via multi-graph propagation technique uses an edge direction assignment module 210 to assign a direction between each pair of video shots by comparing the confidence scores of these video shots from concept detection models. The direction is assigned as: the hyperlink will be “out-linked” from the video shot with lower confidence score to the one with higher confidence score, so that a surfer following the out-link of a video shot will reach to a more relevant shot.

FIG. 8 shows an illustration of a directed graph 800. For each edge 704 in the pruned graph 700 in FIG. 7, a direction 806 is assigned from the video shot 802 with lower concept confidence score to that with higher score, i.e., the vertex 802 that is more relevant to the given topic is “in-linked” by the hyperlink 804 and that the one less relevant is “out-linked” by the hyperlink 804.

1.5.4 Video-PageRank Procedure

Up to now, how the video search re-ranking via multi-graph propagation technique exploits the underlying conceptual and visual similarity relationships between video shots, and simulates the video search problem in a “PageRank fashion” has been explained. In summary, the video search re-ranking via multi-graph propagation technique constructs a uni-graph based on a specific concept in the following procedure: vertex weighting by a text-based search model (FIG. 2, box 216), hyperlink construction by a concept detection model (FIG. 2, box 212), graph pruning by a visual similarity comparison model (FIG. 2, box 214), and hyperlink direction assignment (FIG. 2, box 210) with confidence scores from the concept detection model.

Moreover, given a set of concepts related to a given query, the technique can construct a set of graphs based on each individual concept. Upon the creation of multiple graphs, the technique applies a modified “intelligent surfer” PageRank (ISPR) procedure for video search and uses a graph-based propagation approach to re-ranking the text-based search results. This approach named the “Intelligent Surfer” PageRank algorithm for Video Search (ISPR-VS) herein.

The ISPR-VS procedure can be explained as follows. One assumes that a surfer (similar to a surfer in the web space) is browsing among a graph of video shots and searching for relevant video shots to a given query q. At a specific video shot j, the surfer will choose to select one of the out-links of the current shot uniformly, or jump to a video shot in the entire video corpus randomly. For the next step of browsing, the surfer has two choices: follow a link, with probability (1−d), or jump, with probability d. However, the surfer in a video search task is prescient rather than random walking, as the text-relevance score of each video shot to the query is provided as priori-knowledge. Therefore, the surfer will select the links (or jump) based on his/her interest of query. Instead of selecting among the possible destinations uniformly, the surfer chooses using a probability distribution

$$( \frac{ASR ( q , j )}{{\sum }_{k ∈ G} ASR ( q , k )} ) ,$$

where ASR(q,j) refers to the ASR-based text relevance score of the targeted video shot to the surfer's query. ASR refers to automatic speech recognition, which is widely employed to generate text corpus associated with video data from embedded audio speech.

The ISPR-VS score calculated from the graph constructed on a specific concept c is given by:

$${IS}_{q , c} ( j ) = d \frac{ASR ( q , j )}{{\sum }_{k ∈ G ( c )} ASR ( q , k )} + ( 1 - d ) {\sum }_{i \text{:} i \to j ( c )} {IS}_{q , c} ( i ) \frac{ASR ( q , j )}{{\sum }_{l \text{:} i \to l} ASR ( q , l )} \\ {IS}_{q , c} ( j ) = d \frac{ASR ( q , j )}{{\sum }_{k ∈ G ( c )} ASR ( q , k )} , if shot j doesn \text{’} t map to the concept \qquad ( 11 )$$

where ASR(q,j) represents the ASR-relevance score of shot j to the given query q, generated from the text-based search model. G(c) represents all the video shots in the graph generated on concept c. The parameter d is a parameter similar to that in the static PageRank algorithm, which can be set empirically. The parameter l represents the shots that out-link to the shot j in the graph constructed based on concept c, i.e., l represents the shots that have lower concept confidence score than shot j on the concept c. For the shot that has no relevance to the concept c, an initial text-relevance-based score is given to the shot

$$( d \frac{ASR ( q , j )}{{\sum }_{k ∈ G ( c )} ASR ( q , k )} ) .$$

Thus, for a specific query q, video shot j's query-dependent score within the graph based on a specific concept c can be calculated as IS_{q,c}(j). This re-ranked relevance score will be propagated on each video shot iteratively until convergence, as the ISPR-VS procedure is recursive. More specifically, the relevance score of each shot will be propagated through the graph among its relevant video shots until the re-ranking score is stable, which reflects the relevance of the video shot to the query.

Based on the propagation, one further defines an aggregation algorithm upon multiple graphs. The aggregated score of multi-graph propagation is given by:

$${IS}_{q} ( j ) = {\sum }_{c} {IS}_{q , c} ( j ) \qquad ( 12 )$$

where IS_{q,c}(j) represents the relevance score of video shot j to the query within the graph based on concept c. IS_{q}(j) denotes a linear combination of all the IS_{q,c}(j) scores on the set of query-related concepts. With this combination, the aggregated relevance scores of video shots will be taken as the final re-ranking results.

2.0 The Computing Environment

The video search re-ranking via multi-graph propagation technique is designed to operate in a computing environment. The following description is intended to provide a brief, general description of a suitable computing environment in which the video search re-ranking via multi-graph propagation technique can be implemented. The technique is operational with numerous general purpose or special purpose computing system environments or configurations. Examples of well known computing systems, environments, and/or configurations that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, programmable consumer electronics, network PCs, minicomputers, mainframe computers, distributed computing environments that include any of the above systems or devices, and the like.

FIG. 9 illustrates an example of a suitable computing system environment. The computing system environment is only one example of a suitable computing environment and is not intended to suggest any limitation as to the scope of use or functionality of the present technique. Neither should the computing environment be interpreted as having any dependency or requirement relating to any one or combination of components illustrated in the exemplary operating environment. With reference to FIG. 9, an exemplary system for implementing the video search re-ranking via multi-graph propagation technique includes a computing device, such as computing device 900. In its most basic configuration, computing device 900 typically includes at least one processing unit 902 and memory 904. Depending on the exact configuration and type of computing device, memory 904 may be volatile (such as RAM), non-volatile (such as ROM, flash memory, etc.) or some combination of the two. This most basic configuration is illustrated in FIG. 9 by dashed line 906. Additionally, device 900 may also have additional features/functionality. For example, device 900 may also include additional storage (removable and/or non-removable) including, but not limited to, magnetic or optical disks or tape. Such additional storage is illustrated in FIG. 9 by removable storage 908 and non-removable storage 910. Computer storage media includes volatile and nonvolatile, removable and non-removable media implemented in any method or technology for storage of information such as computer readable instructions, data structures, program modules or other data. Memory 904, removable storage 908 and non-removable storage 910 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 900. Any such computer storage media may be part of device 900.

Device 900 may also contain communications connection(s) 912 that allow the device to communicate with other devices. Communications connection(s) 912 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. The term computer readable media as used herein includes both storage media and communication media.

Device 900 may have various input device(s) 914 such as a display, a keyboard, mouse, pen, camera, touch input device, and so on. Output device(s) 916 such as speakers, a printer, and so on may also be included. All of these devices are well known in the art and need not be discussed at length here.

The video search re-ranking via multi-graph propagation technique may be described in the general context of computer-executable instructions, such as program modules, being executed by a computing device. Generally, program modules include routines, programs, objects, components, data structures, and so on, that perform particular tasks or implement particular abstract data types. The video search re-ranking via multi-graph propagation technique may be practiced in distributed computing environments where tasks are performed by remote processing devices that are linked through a communications network. In a distributed computing environment, program modules may be located in both local and remote computer storage media including memory storage devices.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

Wherefore, what is claimed is:

1. A computer-implemented process for ranking the relevance of video returned in response to a search, comprising:
inputting search results of video shots with text-based relevance scores received in response to a text string search query;
creating a set of hierarchical graphs based on different semantic concepts, with the video shots as vertices and hyperlinks, that exploit conceptual similarity and visual similarity between the video shots, as edges;
applying a topic-sensitive ranking procedure to propagate the text-based relevance scores of the video shots through the hyperlinks in each hierarchical graph of the set of hierarchical graphs; and
aggregating the results of the topic-sensitive ranking procedure from the set of hierarchical graphs to determine the final ranking of the video shot search results.

2. The computer-implemented process of claim 1, further comprising prior to applying the topic-sensitive ranking procedure:
converting the text string search query into an object query that identifies targeted objects in the text string search query; and
modifying the text-based relevance scores by assigning greater weight to video shot search results of text string query terms that represent the targeted objects.

3. The computer-implemented process of claim 1 further comprising constructing each hierarchical graph by:
taking the video shots as vertices wherein each text-relevance score is the weight of the vertex; and
assigning a weight of zero to video shots that are determined to be irrelevant to the text string search query.

4. The computer-implemented process of claim 1, further comprising constructing each hierarchical graph by:
for each of a set of concepts,
using a concept detection model that predicts the likelihood of a video shot being related to a given concept and assigns an associated confidence score; and
classifying each video shot into a positive, relevant category or a negative, irrelevant category; and
ranking the video shots according to their confidence scores of being relevant to the given concept.

5. The computer-implemented process of claim 4 further comprising refining the hyperlinks of each hierarchical graph by:
pruning video shot pairs of the hierarchical graph that are not visually similar by employing a content-based visual similarity model.

6. The computer-implemented process of claim 5 wherein the content-based visual similarity model compares the similarity of the video shots using low level features.

7. The computer-implemented process of claim 6 further comprising using color momentum as the low level features.

8. The computer-implemented process of claim 4, further comprising refining the hyperlinks of each hierarchical graph by:
assigning the direction of the hyperlink for each pair of video shots based on the confidence score of each video shot of the pair of video shots.

9. The computer-implemented process of claim 8, further comprising the direction of the hyperlink from the video shot with a lower confidence score to the video shot with a higher confidence score.

10. The computer-implemented process of claim 1, further comprising computing a set of graphs for each semantic concept.

11. The computer-implemented process of claim 1, further comprising:
for each concept,
computing a query-dependent score for each video shot for each graph;
computing a new relevance score for each video shot using the query dependent score; and
aggregating the new relevance score for each video shot for each graph for the given concept to determine the final ranking of the video shot search results for the given concept.

12. The computer-implemented process of claim 11 further comprising aggregating the final ranking of the video shot search results for each concept to determine the final ranking of the video shot search results for all concepts.

13. A computer-implemented process for ranking the relevance of video shots returned in response to a search, comprising:
inputting video shot search results with text-based relevance scores received in response to a text string search query;
determining a first expansion of query terms by expanding the number of query terms by segmenting the test string search query and computing modified text-based relevance scores using the first expansion of the number of query terms;
determining a second expansion of query terms by expanding the number of query terms by performing name entity generalization;
further modifying the modified text-based relevance scores by identifying targeted objects in the text string search query and the first and second expansions of query terms by assigning greater weight to video shot search results of query terms that represent the targeted objects; and
using the further modified text-based relevance scores and the first and second expansion of query terms to determine the final ranking of the video shot search results.

14. The computer-implemented process of claim 13 further comprising identifying the targeted objects by:
using visual content-based detection to compare query terms to a list of concepts;
using part-of-speech identification to tag nouns and noun phrases in the query as targeted objects;
identifying adverbs that with refinement meanings and taking the noun and noun-phrases following the adverbs with refinement meanings as targeted objects; and
identifying name entities in the query extracting the targeted object by identifying the part of the name which is more often used as the reference of the name entity.

15. The computer-implemented process of claim 13 wherein determining the first expansion of query terms and modified text-based relevance scores further comprises:
segmenting the text string search query into term sequences based on an N-gram method;
inputting term sequences into a search engine as different forms of the query;
aggregating the different video shots retrieved by the search query sequences with different weights, where a higher segment n-gram query is assigned a greater relevance weight.

16. The computer-implemented process of claim 13 wherein determining the second expansion of query terms further comprises further comprises:
using name entity generalization to classify name entities in the text string query into several predefined categories;
assigning each name entity a label of its corresponding category;
tagging names in both the text string query and database elements in a database being searched with the same set of category labels; and
using the tagged names to retrieve database elements that contain the same tagged names as are in the text string query.

17. The computer-implemented process of claim 13 wherein using the further modified text-based relevance scores and first and second expansion of query terms to determining the final relevance, further comprises using query term frequency and semantic importance of the targeted objects in re-weighting the text-based relevance scores.

18. A system for ranking the results of video data returned in response to a search query, comprising:
a general purpose computing device;
a computer program comprising program modules executable by the general purpose computing device, wherein the computing device is directed by the program modules of the computer program to,
input a ranked set of video shot search results received in response to a text-based search query;
using the ranked set of video shot search results, construct a set of graphs based on semantic similarity with video shots as vertices and semantic concept similarity and visual similarity between video shots as hyperlinks; and
apply a topic sensitive ranking procedure to the set of graphs to re-rank the ranked set of video shots.

19. The system of claim 18, wherein the module to construct a set of graphs further comprises modules to:
weight each vertex of each graph by using a text-based search model;
construct each hyperlink of each graph by employing a concept detection model;
prune each graph by employing a visual similarity comparison model; and
assign each hyperlink of each graph a direction assignment with a confidence score computed using the concept detection model.

20. The system of claim 17, further comprising a module to use object-sensitive query analysis to modify the ranking of the ranked set of video shots prior to constructing the set of graphs.
